(19) United States
(12) Patent Application Publication
(10) Pub. No.: US 2024/0362669 A1
(43) Pub. Date: Oct. 31, 2024

(54) SMART CONTRACT-INTEGRATED KEYBOARD DATA COLLECTION AND REWARDS SYSTEM

(71) Applicant: Jorge Checo, West New York, NJ (US)

(72) Inventor: Jorge Checo, West New York, NJ (US)

(21) Appl. No.: 18/767,426

(22) Filed: Jul. 9, 2024

Related U.S. Application Data
(63) Continuation of application No. 17/822,038, filed on Aug. 24, 2022, now abandoned.

(51) Int. Cl. G06Q 30/0207; G06Q 20/36; G06Q 30/0251

(52) U.S. Cl. CPC G06Q 30/0236; G06Q 20/3678; G06Q 30/0267; G06Q 2220/10

(57) ABSTRACT

A method of incentivizing a consumer to share data useful for ad targeting includes providing a mobile application with a dedicated digital keyboard and an integrated blockchain wallet; collecting first person data typed into the keyboard according to a smart contract; storing the data on a data storage medium; and rewarding the consumer for sharing the data. A system for incentivizing the consumer to share the data includes a mobile computing device having a processor and a memory. A mobile application resident on the memory includes a keyboard graphical interface integrated with a smart contract dashboard and a cryptocurrency wallet address. The consumer can generate a passive income. The keyboard system can replace cookies as a method of obtaining 1st party data for advertisers.

### CROSS-REFERENCE TO RELATED APPLICATIONS

This application is a continuation of U.S. application Ser. No. 17/822,038, filed August 24, 202, titled “SMART CONTRACT-INTEGRATED KEYBOARD DATA COLLECTION AND REWARDS SYSTEM,” the entire contents of which are herein incorporated by reference.

### BACKGROUND OF THE INVENTION

The present invention relates to collection of consumer data and, more particularly, to a smart contract-integrated keyboard data collection and rewards system.

Consumers are increasingly wary about sharing their data, making it difficult for advertisers to effectively target customers. Of surveyed consumers, 81% say they see more risks than benefits when it comes to sharing data with companies. Governments are making things worse for advertisers by imposing stricter legislation.

Traditional incentive-based software programs oblige users to scan receipts, watch ads, complete surveys, and carry out other time-consuming, tedious tasks. They offer little meaningful monetary benefit to users and do not deliver tailored advertising for businesses.

U.S. Pat. No. 11,170,399 teaches a browser-based advertising platform and rewards system, i.e., a plug-in or the like, which obtains implicit or explicit permission from a consumer to display ads in return, e.g., for access to the consumer's browsing history.

U.S. Pat. No. 11,334,876 discloses a method for exchanging digital tokens, comprising a messaging app that uses a digital keyboard for token instructions. The keyboard is not part of the app. The method includes embedding a token in selectable media content in a text message. The recipient can select the selectable media content to accept the digital token into a digital wallet. The keyboard includes emoji representative of the token. Digital tokens are transferred in response to keyboard interactions.

The disclosures of the above references are incorporated herein by reference.

As can be seen, there is a need for a method of collecting consumer data without overburdening the consumer and delivering the data to businesses including advertisers, enabling targeted advertising.

### SUMMARY OF THE INVENTION

In one aspect of the present invention, a method of incentivizing a consumer to share data useful for ad targeting comprises providing to the consumer a mobile application with a dedicated digital keyboard and an integrated blockchain wallet; collecting first person data typed into the dedicated digital keyboard according to a smart contract; storing the first person data on at least one data storage medium; and rewarding the consumer for sharing the first person data typed into the dedicated digital keyboard.

In another aspect of the present invention, a system for incentivizing a consumer to share data useful for ad targeting comprises at least one mobile computing device comprising a processor and a memory; and a mobile application resident on the memory comprising a keyboard graphical interface integrated with a smart contract dashboard and a cryptocurrency wallet address, wherein the mobile application is configured to execute the method.

The inventive keyboard system enables consumers to generate a passive income while providing advertisers a broader reach and more detailed knowledge about their customers. The keyboard system may replace cookies as a method of obtaining 1st party data for advertisers.

These and other features, aspects and advantages of the present invention will become better understood with reference to the following drawings, description, and claims.

### BRIEF DESCRIPTION OF THE DRAWINGS

FIG. 1 is a flow chart of a method of utilizing a system according to an embodiment of the present invention, illustrating the user experience;

FIG. 2 is a block diagram of a system according to an embodiment of the present invention;

FIG. 3 is another block diagram thereof, illustrating a subset of the system;

and

FIG. 4 is a block diagram of the system architecture.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a mobile application comprising a Web3 keyboard integrated with a Smart Contract dashboard and a crypto wallet, enabling type-to-earn functionality.

The inventive keyboard is sometimes referred to herein as the “Unblok Keyboard”.

Features of the inventive keyboard may include but are not limited to voice typing, multi-lingual typing, keyword prediction, autocorrect, auto-capitalization, location access, search engine, optical character recognition, Web3, rewards, crypto tokens, NFTs, and real-time user opt out of data collection, i.e., the user can instantly deactivate components. NFTs may include themes, stickers, emojis, and avatars.

The mobile app enables users (i.e., consumers) to spend more time on their phones engaging in activities they enjoy rather than trying to collect reward points and miles and worrying about using them before they expire. Data is collected from the Keyboard unless Private mode is enabled. The users may simply use the new keyboard and enjoy their favorite apps as they may have done previously. As they type into distributed applications, browsers, and messages, the keyboard software collects 1st Person (1P) Data, as well as metadata including location. The collected data is available to the user, who may look up data produced by mobile apps on a user earnings dashboard.

The consumer may be rewarded by crypto tokens that may be redeemed for non-fungible tokens (NFTs), gift cards, miles, exclusive prizes, etc., changing the risk-reward calculation for data sharing. The amount of cryptocurrency (or “crypto”) earned by users is computed by a connected crypto wallet based on a keyword pricing algorithm driven by feedback from data sales up to a monthly maximum limit and deposited into the wallet. Rewards denominations may be selected from the group consisting of: cryptocurrencies, non-fungible tokens (NFT), points, miles, gift cards, subscriptions, games, etc., and traditional fiat currencies. The rewards denomination may be exchanged for another denomination with the wallet via transactions on different protocols. The keyboard and crypto wallet may be installed in any sequence provided both are present.

The 1st person data may be processed and analyzed in a data preparation stage and sold via retail media and advertising marketplaces to customers.

The mobile app collects non-identifying data that users type as well as metadata and shares it with businesses, improving the businesses' ability to compete in the marketplace. For example, companies interested in security, travel, data analytics, and artificial intelligence (AI) may use the information the app collects. The 1st Person data may be sold via retail media and advertising marketplaces to data buyers e.g., advertisers, researchers, and vendors who do outreach to mobile users via decentralized applications (D-apps), browsers and/or messaging apps, in some cases by way of notifications.

The Unblok Keyboard is integrated at the top of a Web 3 Stack at a user experience layer between the mobile users and a mobile application layer, which may include, for example, Facebook™, Amazon™, Google®, etc. The keyboard interacts with blockchain distributed apps that may integrate blockchain modular components such as wallets, blockchain browsers, and distributed databases. Mobile app client-side software operating on an operating system layer, such as Android™ or iOS, on a hardware layer, such as iPhone®, Samsung™, Microsoft™, etc. interact with external servers via an infrastructure layer, e.g., WI-FI®, Verizon®, AT&T®, T-Mobile®, etc. The user's collected data may be stored on blockchain platforms interacting with a smart contract.

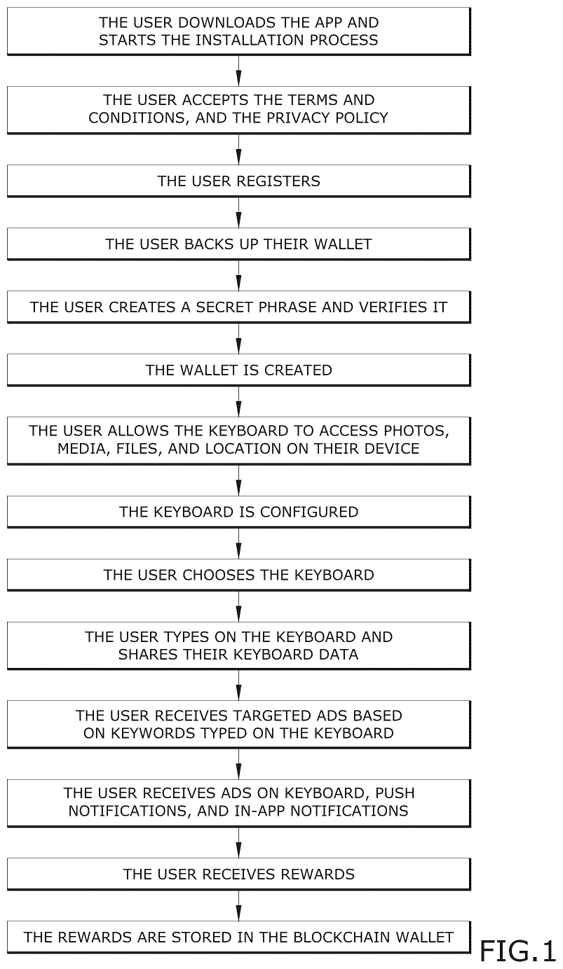

Referring to FIGS. 1 through 4, FIG. 1 illustrates a method of using a mobile app with a 1st person data-collecting keyboard application according to an embodiment of the present invention. Prior to use, the user downloads the app, installs the app, agrees to the terms of service and the privacy policy, registers, backs up and/or sets up a crypto wallet(s) with a secret phrase, and sets up the keyboard(s). Set up may include choosing which apps to use to earn crypto and enabling the keyboard to access photos, media, files, and/or location on the mobile device. Once the keyboard is set up, the user may type on the new keyboard (i.e., on their phone), receiving targeted adds based on the keywords they have typed, as well as push notifications and/or in-app notifications, and receiving crypto rewards in exchange for the data collected in the background on their chosen mobile apps. The rewards are stored in the user's wallet.

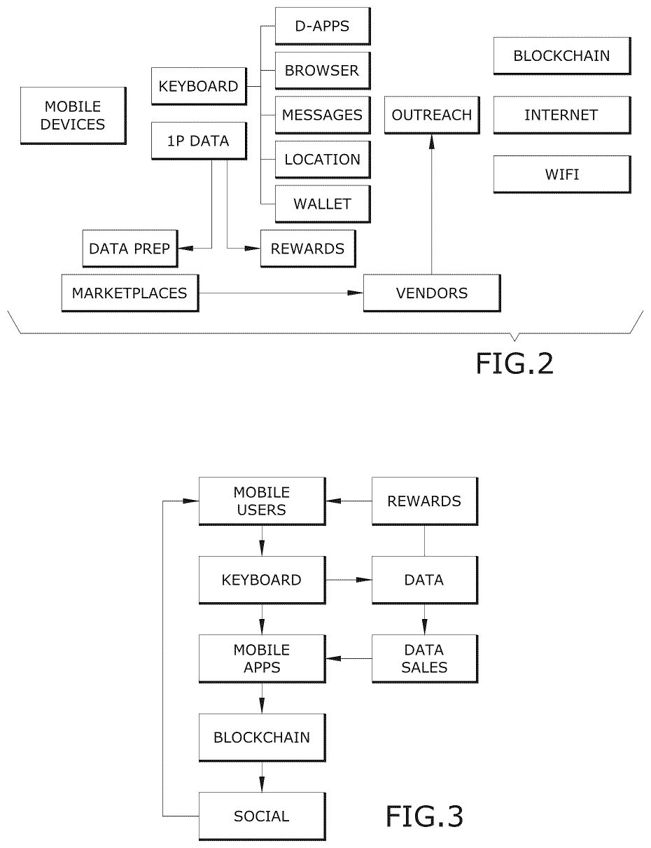

FIG. 2 shows a system according to an embodiment of the present invention. The keyboard is utilized on a mobile device to interact with applications selected from the group consisting of D-apps, a browser, messages, location, wallet, and combinations thereof. As the keyboard is used, it collects 1st person data which is processed in a data preparation server and is analyzed to quantify rewards available to the user. The prepared data is sold via marketplaces to vendors who perform outreach to users. Interactions are performed via internet and/or WI-FI® managed with blockchain.

As shown in FIG. 3, the consumer or mobile user types on the inventive keyboard to interact with various mobile apps. The left hand column represents a Web3 stack. The right hand column represents first person data. The keyboard collects data regarding the consumer and the system rewards the consumer and sells the collected data. Blockchain connects the mobile apps to social media communities, encouraging more mobile users to utilize the inventive keyboard app in a flywheel effect.

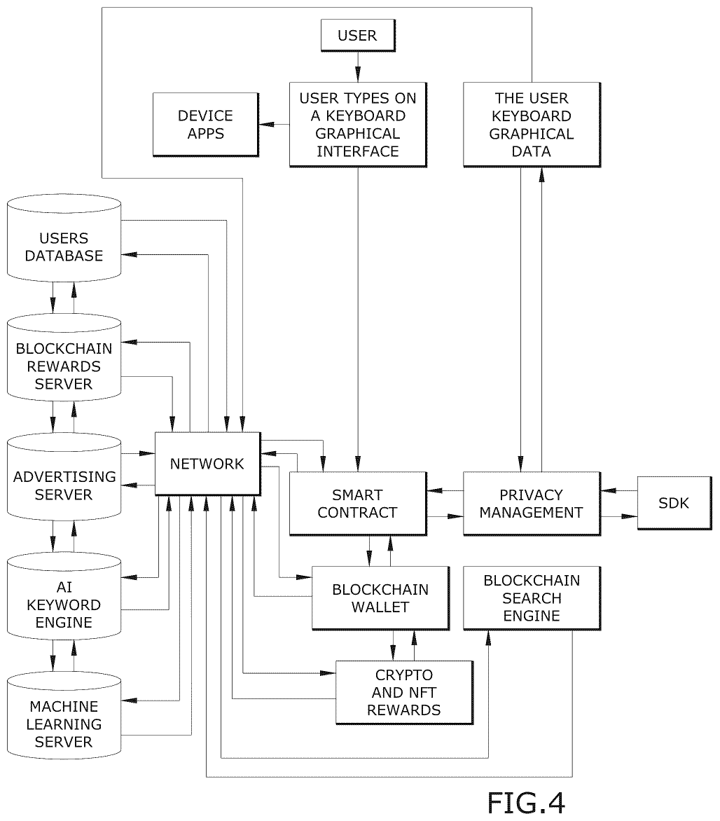

FIG. 4 illustrates interaction of software components of the inventive system as the user types on the keyboard graphical interface to interact with device apps. The keyboard software collects data (typed-in and metadata) determined according to a smart contract, giving the user opt-in/opt-out selections for types and sources of data to be shared. The smart contract determines the privacy management functions of the system developed with a software development kit (SDK). The smart contract modifies interactions via a network with a users database, a blockchain rewards server, an advertising server, an Al keyword engine, a machine learning server, and a blockchain search engine. The smart contract also modifies interactions with a blockchain wallet which receives stores, and trades crypto and NFT rewards via the network. The blockchain rewards server interacts with the users database to track and deliver rewards and with the advertising server to determine the rewards value of the user's data. The advertising server utilizes the Al keyword engine in conjunction with the machine learning server to target advertising to the user.

It should be understood, of course, that the foregoing relates to exemplary embodiments of the invention and that modifications may be made without departing from the spirit and scope of the invention as set forth in the following claims.

What is claimed is:

1. A method of incentivizing a consumer to share data useful for ad targeting, comprising:
providing to the consumer a mobile application with a dedicated digital keyboard and an integrated blockchain wallet;
collecting first person data typed into the dedicated digital keyboard according to a smart contract;
storing the first person data on at least one data storage medium; and
rewarding the consumer for sharing the first person data typed into the dedicated digital keyboard.

2. The method of claim 1, wherein the smart contract provides the consumer a real-time user opt out of collecting the first person data, the real-time user opt out comprising:
choosing applications to use to earn cryptocurrency; and
enabling the dedicated digital keyboard to access one or more of photos, media, files, and location.

3. The method of claim 1, wherein the first person data is not collected from the dedicated digital keyboard when a private mode is enabled.

4. The method of claim 1, further comprising collecting metadata.

5. The method of claim 1, further comprising displaying to the consumer on a user earnings dashboard the first person data collected.

6. The method of claim 1, wherein the rewarding comprises transferring an amount of cryptotokens calculated by applying a predetermined keyword pricing algorithm to the integrated blockchain wallet.

7. The method of claim 1, wherein the rewarding comprises:
transferring to the integrated blockchain wallet an amount of reward selected from the group consisting of: cryptocurrency, non-fungible tokens, and traditional fiat currencies.

8. The method of claim 1, further comprising:
processing the first person data;
analyzing the first person data; and
selling the first person data via a marketplace to customers.

9. The method of claim 1, further comprising:
displaying targeted adds based on keywords within the first person data;
pushing notifications;
and displaying in-application notifications.

10. A system for incentivizing a consumer to share data useful for ad targeting, comprising:
at least one mobile computing device comprising a processor and a memory; and
a mobile application resident on the memory comprising a keyboard graphical interface integrated with a smart contract dashboard and a cryptocurrency wallet address, wherein the mobile application is configured to execute the method of claim 1.

11. The system of claim 10, wherein the mobile application is configured to interact with an application selected from the group consisting of a decentralized application; a browser; a messaging application; a location application, a wallet application; and combinations thereof.

12. The system of claim 10, further comprising a data preparation server operative to process and analyze the first person data and to quantify rewards accordingly.

13. The system of claim 10, wherein the smart contract dashboard provides the user selections to opt-in and opt-out of sharing types of the first person data and of sharing sources of the first person data.

14. The system of claim 10, further comprising components selected from the group consisting of: a network; a users database; a blockchain rewards server; an advertising server; an artificial intelligence keyword engine; a machine learning server; a blockchain search engine; and combinations thereof.

15. The system of claim 10, wherein the cryptocurrency wallet address is operative to write transaction data to a blockchain.

16. The system of claim 10, further comprising a blockchain platform operative to interact with the smart contract dashboard and with the cryptocurrency wallet address.
